(19) United States
(12) Patent Application Publication
(10) Pub. No.: US 2016/0073331 A1
(43) Pub. Date: Mar. 10, 2016

(54) Circuit Switched Fallback Optimization In Wireless Devices

(71) Applicant: Apple Inc., Cupertino, CA (US)

(72) Inventors: Swaminathan Balakrishnan, Santa Clara, CA (US); Sindhu Sivasankaran Nair, Walnut Creek, CA (US); Tarik Tabet, Los Gatos, CA (US); Sarma V. Vangala, San Jose, CA (US)

(21) Appl. No.: 14/844,241

(22) Filed: Sep. 3, 2015

Related U.S. Application Data
(60) Provisional application No. 62/046,849, filed on Sep. 5, 2014.

(51) Int. Cl. H04W 48/16; H04L 12/66; H04W 4/02

(52) U.S. Cl. CPC H04W 48/16; H04W 4/02; H04L 12/66

(57) ABSTRACT

Instead of barring an LTE network for the Long Bar Time duration (LBT) if the LTE cell doesn't support CSFB, a wireless communication device may perform a scan for LTE networks before expiration of the LBT if the UE has changed its location. When the UE is in LTE acquisition mode, or the necessary information about a CS network for CSFB is unavailable, the UE may maintain its state on both the LTE and CS network, and check CS paging messages to see if the UE can decode any status. Unlike for CSFB, checking for overhead messages may be performed over the LTE system, and the UE may wake up on CS pages to determine if a suitable network is available. By maintaining its state on both types of networks, the UE may use LTE for data services which would otherwise be provided by different systems for the CS networks when messages transmitted over LTE do not include CS registration information.

### PRIORITY CLAIM

This application claims benefit of priority of U.S. Provisional Patent Application Ser. No. 62/046,849 titled “Circuit Switched Fallback Optimization In Wireless Devices”, filed on Sep. 5, 2014, which is hereby incorporated by reference as though fully and completely set forth herein.

### FIELD OF THE INVENTION

The present application relates to wireless communication, and more particularly to optimizing circuit switched fallback among wireless communications devices.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is the technology of choice for the majority of wireless network operators worldwide, providing mobile broadband data and high-speed Internet access to their subscriber base. LTE defines a number of downlink (DL) physical channels, categorized as transport or control channels, to carry information blocks received from the MAC and higher layers. LTE also defines three physical layer channels for the uplink (UL). The LTE standard supports packet switching with its all-IP network. However, voice calls in any of the wireless communication standards, such as GSM (Global Systems for Mobile), UMTS (Universal Mobile Telecommunications System) and CDMA2000 (Code Division Multiple Access 2000) are circuit switched, so with the adoption of LTE, carriers modified their voice call network in order to accommodate LTE.

Three different approaches have been taken in ensuring the seamless transmission of both voice calls and data over LTE. One approach is Voice over LTE (VoLTE), which is based on the Internet Protocol Multimedia Subsystem (IMS) network, with specific profiles for control and media planes of voice service on LTE defined by GSMA (GSM Association) in PRD (Products Requirement Document) IR.92. The voice service is delivered as data flows within the LTE data bearer. Consequently, there is no dependency on the legacy circuit switched voice network (CSVN). In a second approach, simultaneous voice and LTE (SVLTE), the mobile device operates simultaneously in the LTE and circuit switched (CS) modes, with the LTE mode providing data services and the CS mode providing the voice service. This is a solution solely based on the device, which does not have special requirements on the network and does not require the deployment of IMS. However, this solution can require expensive phones with high power consumption.

A third approach is referred to as CS fallback (CSFB), according to which LTE provides data services, but when a voice call is initiated or received, communication falls back to the CS domain. Operators may simply upgrade the MSC (Mobile Service Center) instead of deploying the IMS, and therefore, can provide services quickly. However, the disadvantage is longer call setup delay. While VoLTE has been widely accepted as the desired solution for the future, the demand for voice calls today has led LTE carriers to introduce CSFB as a stopgap measure. When placing or receiving a voice call, LTE handsets fall back to 2G or 3G networks for the duration of the call.

In other words, while 3GPP (Third Generation Partnership Project) LTE technology has reached a certain level of maturity, there continues to be innovation in the area of network deployment strategies, the result of which are challenges to the user experience regarding voice calls. Furthermore, existing LTE network deployments continue to expose “corner cases” in which the voice calling user experience is sub-par. CSFB has been launched commercially by multiple MNOs (Mobile Network Operators). Compared to native CS calls, CSFB deployments continue to expose various problems such as additional call setup time, IRAT (Inter-Radio Access Technology) cell re-selection/handover failures and the inefficient return back to E-UTRAN (Evolved Universal Terrestrial Access Network), all of which severely impact user experience.

### SUMMARY OF THE INVENTION

In one set of embodiments, a wireless communication device, or wireless user equipment device (UE) may transition between communicating on a first network that operates according to a first radio access technology (RAT), e.g. a packet switching (PS) long term evolution (LTE) network, and a second network that operates according to a second RAT, e.g. a circuit switching (CS) 1X network, using optimized circuit switched feedback (CSFB) procedures. The UE may scan for LTE networks to move back into CSFB/eCSFB mode whenever needed while the UE is communicating over the CS network. The UE, while communicating over the CS network, may determine that an identified LTE network does not support CSFB. The UE may nominally bar the LTE network for a specified time duration, e.g. for a Long Bar timer duration, but make a decision whether to begin scanning for LTE networks prior to the expiration of the Long Bar timer duration, responsive to the status of the location of the UE during a specified time span.

Specifically, the UE may decide to scan for LTE networks prior to the expiration of the Long Bar timer duration responsive to the UE continuously changing its location during the specified time span. In contrast, the UE may allow the specified Long Bar timer duration to expire before scanning for LTE networks again, responsive to the UE not continuously changing its location during the specified time span.

In some embodiments, while the UE is operating in LTE acquisition mode, the UE may maintain its state on both the LTE and CS network, and check CS paging messages to determine whether the UE is capable of decoding the UE's status. In other words, when the UE is in LTE acquisition mode, or necessary information about a CS network for CSFB is unavailable, the UE may maintain its state on both the LTE and CS network, and may check CS paging messages to see if the UE can decode any status. Unlike for CSFB, checking for overhead messages may be performed over the LTE system, and the UE may wake up on CS pages to determine if a network is available. By maintaining its state on both types of networks, the UE may also use LTE for data services which would otherwise be provided by different systems for the CS networks when no CS registration information was included in messages transmitted over LTE.

This enables the UE not to have to remain in 1×/HDR (High Dynamic Range) mode for long durations, especially when the UE has physically moved to a different location. In addition, the UE may thereby not miss 1× pages while the device is in Suspend/Resume LTE (SRLTE) mode.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 shows an exemplary (and simplified) wireless communication system;

FIG. 2 shows an exemplary base station in communication with an exemplary wireless user equipment (UE) device according to some embodiments;

FIG. 3 shows an exemplary block diagram of a UE, according to some embodiments;

FIG. 4 shows an exemplary block diagram of a base station, according to some embodiments;

FIG. 5 shows an exemplary block diagram of a cellular communication network according to some embodiments;

FIG. 6 shows a more detailed block diagram of a cellular communication network including both LTE and a 3GPP network according to some embodiments;

FIG. 7 shows a flowchart diagram illustrating an exemplary method for performing optimized circuit switched fallback operation in wireless devices according to some embodiments; and

FIG. 8 shows a flowchart diagram illustrating an exemplary method of operating a UE device that can communicate over different radio access technologies, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:

UE: User Equipment

BS: Base Station

CS: Circuit Switched

PS: Packet Switched

CSFB: Circuit Switched Fallback

eCSFB: enhanced CSFB

DL: Downlink (from BS to UE)

UL: Uplink (from UE to BS)

FDD: Frequency Division Duplexing

TDD: Time Division Duplexing

GSM: Global System for Mobile Communication

LTE: Long Term Evolution

SRLTE: Suspend/Resume LTE

IE: Information Element

LBT: Long Bar Timer

RAT: Radio Access Technology

IRAT: Inter-Radio Access Technology

TX: Transmission

RX: Reception

UMTS: Universal Mobile Telecommunication System

### TERMS

The following is a glossary of terms that may appear in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station (BS)—The term “Base Station” has the full breadth of its ordinary meaning, and at least includes a wireless communication station installed at a fixed location and used to communicate as part of a wireless telephone system or radio system.

Processing Element—refers to various elements or combinations of elements that are capable of performing a function in a device, e.g. in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

DCI—refers to downlink control information. There are various DCI formats used in LTE in PDCCH (Physical Downlink Control Channel). The DCI format is a predefined format in which the downlink control information is packed/formed and transmitted in PDCCH.

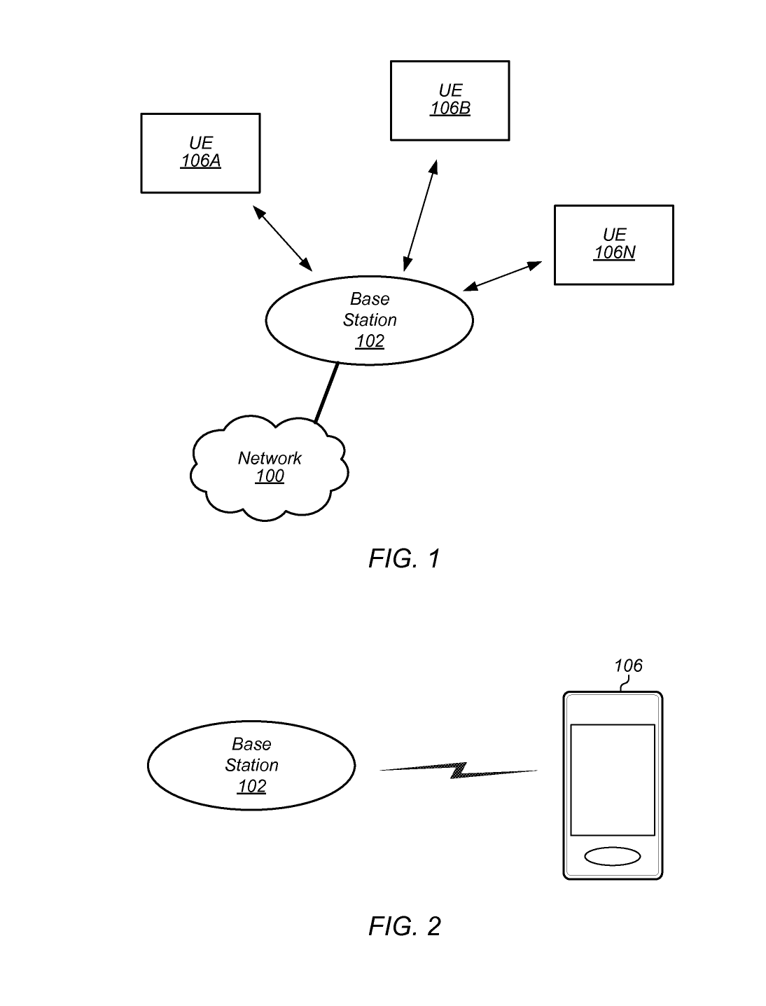

### FIGS. 1 and 2—Exemplary Communication Systems

FIG. 1 illustrates an exemplary (and simplified) wireless communication system. It is noted that the system of FIG. 1 is merely one example of a possible system, and embodiments may be implemented in any of various systems, as desired. As shown, the exemplary wireless communication system includes a base station 102 which communicates over a transmission medium with one or more user devices 106A through 106N. Each of the user devices may be referred to herein as a “user equipment” (UE) or UE device. Thus, the user devices 106A-106N are referred to as UEs or UE devices. Furthermore, when referring to an individual UE in general, user devices are also referenced herein as UE 106 or simply UE.

The base station 102 may be a base transceiver station (BTS) or cell site, and may include hardware that enables wireless communication with the UEs 106A through 106N. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication between the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), 3GPP2 CDMA2000 (e.g., 1×RTT, 1×EV-DO, HRPD, eHRPD), Wi-Fi, WiMAX etc. In some embodiments, the base station 102 communicates with at least one UE using improved UL (Uplink) and DL (Downlink) decoupling, preferably through LTE or a similar RAT standard.

UE 106 may be capable of communicating using multiple wireless communication standards. For example, a UE 106 might be configured to communicate using either or both of a 3GPP cellular communication standard (such as LTE) or a 3GPP2 cellular communication standard (such as a cellular communication standard in the CDMA2000 family of cellular communication standards). In some embodiments, the UE 106 may be configured to communicate with base station 102 according to improved circuit switched fallback (CSFB) methods as described herein. Base station 102 and other similar base stations operating according to the same or a different cellular communication standard may thus be provided as one or more networks of cells, which may provide continuous or nearly continuous overlapping service to UE 106 and similar devices over a wide geographic area via one or more cellular communication standards.

The UE 106 might also or alternatively be configured to communicate using WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

FIG. 2 illustrates an exemplary system in which user equipment 106 (e.g., one of the devices 106-1 through 106-N) is in communication with the base station 102. The UE 106 may be a device with wireless network connectivity such as a mobile phone, a handheld device, a wearable device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, WLAN, or GNSS. Other combinations of wireless communication standards are also possible.

The UE 106 may include one or more antennas for communicating using one or more wireless communication protocols. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios which are shared between multiple wireless communication protocols, and one or more radios which are used exclusively by a single wireless communication protocol. For example, the UE 106 may include a shared radio for communicating using either of LTE or CDMA2000 1×RTT, and separate radios for communicating using each of WiFi™ and BLUETOOTH™. Other configurations are also possible.

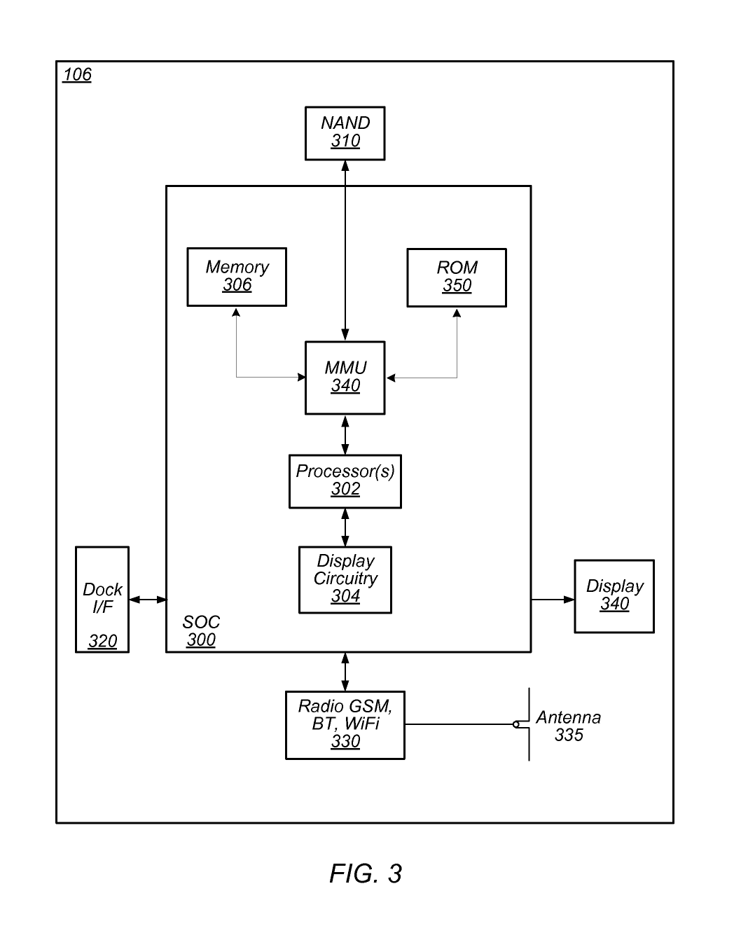

### FIG. 3—Exemplary Block Diagram of a UE

FIG. 3 illustrates an exemplary block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 340. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 340. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 340, and wireless communication circuitry (e.g., for LTE, LTE-A, CDMA2000, BLUETOOTH™, WiFi™, GPS, etc.). The UE device 106 may include at least one antenna 335, and possibly multiple antennas 335, for performing wireless communication with base stations and/or other devices. For example, the UE device 106 may use antenna(s) 335 to perform the wireless communication. As noted above, the UE may be configured to communicate wirelessly using multiple wireless communication standards in some embodiments.

As described further subsequently herein, the UE 106 (and base station 102) may include hardware and software components for implementing a method for optimized handling of CSFB. The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit), or as a combination of general purpose microprocessor, FPGA and/or ASIC. Furthermore, processor 302 may be coupled to and/or may interoperate with other components as shown in FIG. 3, to implement optimized CSFB handling according to various embodiments disclosed herein.

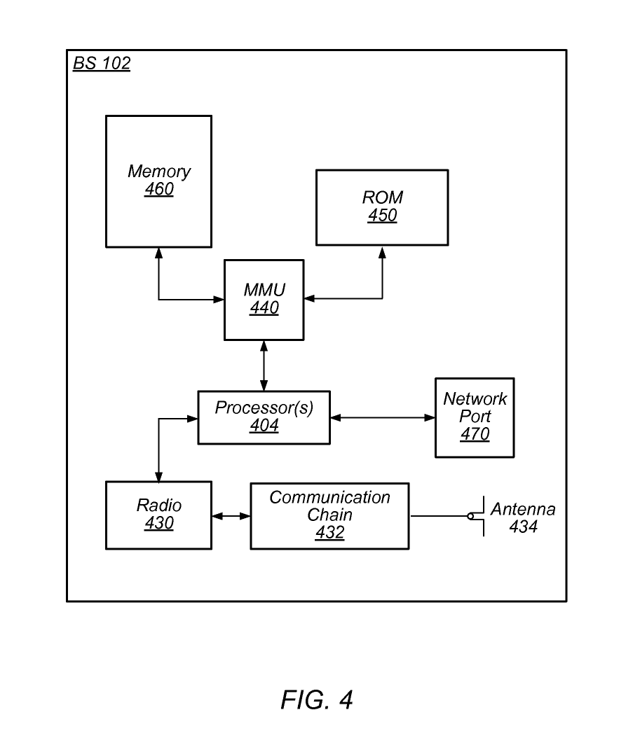

### FIG. 4—Exemplary Block Diagram of a Base Station

FIG. 4 illustrates an exemplary block diagram of a base station 102. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas 434. The antenna(s) 434 may be configured to operate as a wireless transceiver and may be further configured to communicate with UE devices 106 via radio 430. The antenna 434 may communicate with the radio 430 via communication chain 432. Communication chain 432 may be a receive chain, a transmit chain or both. The radio 430 may be configured to communicate via various wireless telecommunication standards, including, but not limited to, LTE, LTE-A WCDMA, CDMA2000, etc. The processor 404 of the base station 102 may be configured to implement part or all of the methods described herein for improved CSFB handling, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof.

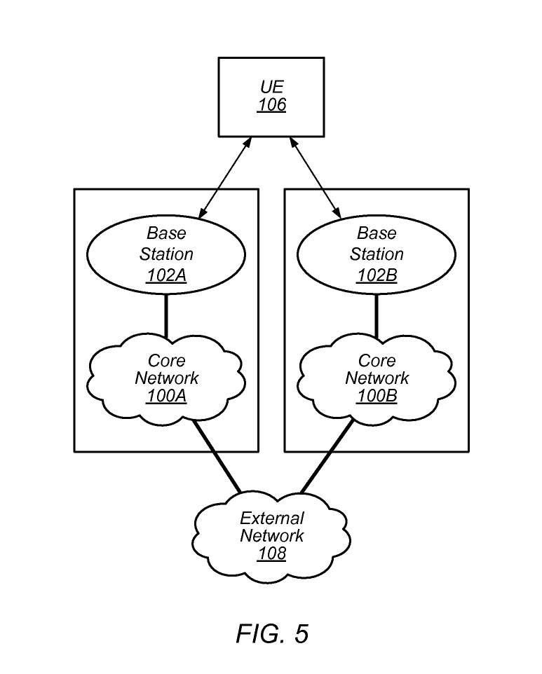

### FIG. 5—Communication System

FIG. 5 illustrates an exemplary (and simplified) wireless communication system. It is noted that the system of FIG. 5 is merely one example of a possible system, and embodiments may be implemented in any of various systems, as desired.

As shown, the exemplary wireless communication system includes base stations 102A and 102B which communicate over a transmission medium with one or more user equipment (UE) devices, represented as UE 106. The base stations 102 may be base transceiver stations (BTS) or cell sites, and may include hardware that enables wireless communication with the UE 106. Each base station 102 may also be equipped to communicate with a core network 100. For example, base station 102A may be coupled to core network 100A, while base station 102B may be coupled to core network 100B. Each core network may be operated by a respective cellular service provider, or the plurality of core networks 100A may be operated by the same cellular service provider. Each core network 100 may also be coupled to one or more external networks (such as external network 108), which may include the Internet, a Public Switched Telephone Network (PSTN), and/or any other network. Thus, the base stations 102 may facilitate communication between the UE devices 106 and/or between the UE devices 106 and the networks 100A, 100B, and 108.

The base stations 102 and the UEs 106 may be configured to communicate over the transmission medium using any of various radio access technologies (“RATs”, also referred to as wireless communication technologies or telecommunication standards), such as GSM, UMTS (WCDMA), LTE, LTE Advanced (LTE-A), 3GPP2 CDMA2000 (e.g., 1×RTT, 1×EV-DO, HRPD, eHRPD), IEEE 802.11 (WLAN or Wi-Fi), IEEE 802.16 (WiMAX), etc.

In some embodiments, base station 102A and core network 100A may operate according to a first RAT (e.g., LTE) while base station 102B and core network 100B may operate according to a second (e.g., different) RAT (e.g., GSM, CDMA 2000 or other legacy or circuit switched technologies). The two networks may be controlled by the same network operator (e.g., cellular service provider or “carrier”), or by different network operators, as desired. In addition, the two networks may be operated independently of one another (e.g., if they operate according to different RATs), or may be operated in a somewhat coupled or tightly coupled manner.

Note also that while two different networks may be used to support two different RATs, such as illustrated in the exemplary network configuration shown in FIG. 5, other network configurations implementing multiple RATs are also possible. As one example, base stations 102A and 102B might operate according to different RATs but couple to the same core network. As another example, multi-mode base stations capable of simultaneously supporting different RATs (e.g., LTE and GSM, LTE and CDMA2000 1×RTT, and/or any other combination of RATs) might be coupled to a core network that also supports the different cellular communication technologies. In one embodiment, the UE 106 may be configured to use a first RAT that is a packet-switched technology (e.g., LTE) and a second RAT that is a circuit-switched technology (e.g., GSM or 1×RTT).

As discussed above, UE 106 may be capable of communicating using multiple RATs, such as those within 3GPP, 3GPP2, or any desired cellular standards. The UE 106 might also be configured to communicate using WLAN, BLUETOOTH™, one or more global navigational satellite systems (GNSS, e.g., GPS or GLONASS), one and/or more mobile television broadcasting standards (e.g., ATSC-M/H or DVB-H), etc. Other combinations of network communication standards are also possible.

Base stations 102A and 102B and other base stations operating according to the same or different RATs or cellular communication standards may thus be provided as a network of cells, which may provide continuous or nearly continuous overlapping service to UE 106 and similar devices over a wide geographic area via one or more radio access technologies (RATs).

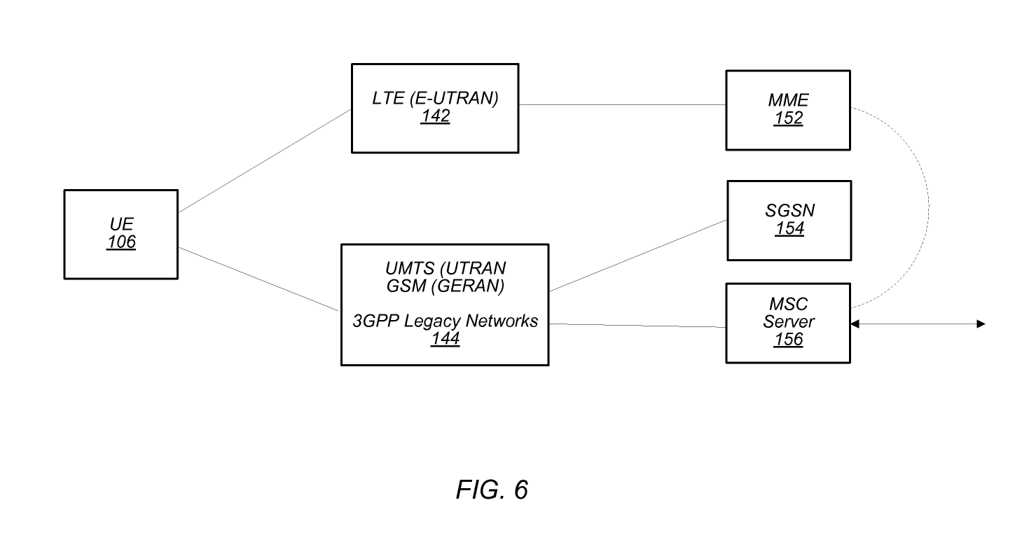

FIG. 6—Exemplary Communication Scenario with CSFB

FIG. 6 illustrates a more detailed example of a communication scenario that may involve CSFB. More particularly, FIG. 6 shows a simplified view of an example network architecture with parallel LTE and 2G/3G networks. As shown in FIG. 6, the LTE network 142 and the legacy 2G/3G network 144 may co-exist in the same geographic area, wherein both networks reside between the User Equipment (of a mobile customer, for example) and the common core network. The common core network may comprise an MME (Mobility management Entity) 152, an SGSN (Serving GPRS Support Node) 154, and an MSC (Mobile Switching Center) Server 156. GPRS refers to the General Packet Radio Service, which is a packet oriented mobile data service on 2G and 3G GSM (Global System for Mobile communications) networks.

The MME 152 may be operated to serve UEs while communicating using LTE. The SGSN 154 may be operated to serve UEs when they are communicating utilizing data services using 2G/3G networks. The MSC Server 156 may be operated to serve UEs when utilizing voice services using 2G/3G networks. The MSC Server 156 connects to the carrier's telephony network. The MME 152 connects to the MSC Server 156 to support CS Fallback signaling and SMS transfer for LTE devices.

The interface (SGSN) 154 situated between the MSC Server 156 and the LTE Mobile Management Entity (MME) 152 enables the UE to be both circuit-switched (CS) and packet-switched (PS) registered while on the LTE access network. This interface also enables the delivery of CS pages as well as SMS communications via the LTE access, without the UE having to leave the LTE network.

A CSFB operation may generally take place as follows. When a UE is currently communicating with the LTE network, i.e., a default LTE data network connection is established with/for the UE, a mobile terminating (incoming) CS voice call may arrive at the MSC server 156. This incoming CS voice call may trigger a page via LTE to the UE device (operated by the user, for example). The page may in turn initiate a CSFB operation. In performing the CSFB operation, the UE may transmit an extended service request to the network to transition to the appropriate 2G/3G network. Once the UE has transitioned from the LTE network to the appropriate 2G/3G network, legacy call setup procedures may be performed to setup the CS call. Mobile originating (outgoing) calls may follow the same transition from LTE (packet switched, or PS) to 2G/3G (circuit switched, or CS), except that the paging step may not be needed. When a CSFB occurs from an LTE network to a 3G network, PS data sessions may also move to the 3G network for simultaneous voice and data services. When a CSFB occurs from an LTE network to a 2G network, PS data sessions may be suspended until the voice call ends and the UE device returns to the LTE network, unless the 2G network supports dual transfer mode (DTM), which permits simultaneous voice and data transmissions. When the voice call ends, the UE device may return to the LTE network via idle mode or connected mode mobility procedures.

As described above, when an incoming call arrives and the UE device is paged via LTE, or when the UE initiates an outgoing call, the UE device may switch from an LTE network to a (selected) 2G/3G network. Acquisition of the 2G/3G network and setup of the call may take place through a number of procedures, including a handover or a redirection. During a handover procedure, the target cell may be selected by the network, i.e. by a base station facilitating communications for the UE in that network, and prepared in advance, and the UE may enter this cell directly in connected mode. While still in LTE, Inter-Radio Access Technology (IRAT) measurements of signal strength may be performed prior to making the handover. During a redirection procedure, the target cell may not be preselected for the UE, but rather the UE may be provided with a target frequency. The UE may then select any available cell that is operating on the indicated frequency. The UE may also try other frequencies/RATs if no cell operating on the target frequency is found. Once a cell is found by the UE, the UE may initiate normal call setup procedures. Unlike during a handover, IRAT measurements of signal strength are not needed for a redirection procedure. Accordingly, CSFB performed using a redirection procedure may require less time to identify the most desirable or adequate cell when compared to performing CSFB using a handover procedure.

### Overview of Optimized CSFB in Wireless Devices

Embodiments described herein are directed to improvements that that allow UE (User Equipment) devices to improve Circuit Switched Fallback (CSFB) performance. Various embodiments of wireless communications and network equipment, including UE devices, base stations and/or relay stations, and associated methods described herein facilitate improved CSFB performance during wireless communications, e.g. wireless communications that involve Long Term Evolution (LTE) communications and transmissions. Specifically, various embodiments described herein facilitate optimizing CSFB in UE devices moving between wireless networks offering varying respective support for CSFB and enhanced CSFB (eCSFB). In a general sense, LTE, for example, represents a packet switched (PS) network, while 1×, for example, represents a circuit switched (CS) network. Furthermore, various wireless system operators may provide CS and PS services over specific respective CS and PS networks. That is, specific CS and PS networks are oftentimes operated together, for example 1×/EVDO, GSM/EDGE, etc., when voice calls are carried over the CS network. In those instances, a specific PS network may always be associated with a specific CS network by the wireless system operator.

A mobile device (also referred to as UE) on eCSFB networks (e.g. the Sprint network), typically scans LTE bands to move back into the eCSFB mode whenever needed. During this time period, the mobile device is tuned away from the CS network, (such as 1×, for example), and there is a possibility of missing a mobile terminated (MT) page. Presently, an LTE network (or LTE cell) is barred for up to 12 minutes if that LTE network doesn't support eCSFB, which results in the mobile device moving back to the CS network (e.g. to 1X). Therefore, there is a possibility of the user remaining in the CS network, and not accessing the PS network (e.g. LTE) for the Long Bar Timer duration. In other words, when a UE is on a CS network (e.g. 1X network) and is scanning for LTE networks to get back to an LTE network as soon as possible, and the UE finds an LTE network that doesn't support the eCSFB format, then the UE may not find the parameters for which the UE is searching, and consequently the UE may not be able to connect to that LTE cell. Presently, in such cases the UE “bars” that particular LTE network for a specified time duration (referred to as Long Bar Timer duration), which is presently 12 minutes. That means that the UE remains in 1× (i.e. on the CS network) for that duration.

In some embodiments, the mobility of the device may be associated with a BSR (Better System Re-selection) algorithm. For example, when the UE is in a “driving” or moving state, there is a greater chance of the UE migrating into the coverage area of a different LTE cell than when the UE is in a “stationary” state. Consequently, the eCSFB parameters broadcast by the different LTE network may be different from the eCSFB parameters broadcast by the LTE cell at the UE's original location. Thus, instead of the UE waiting for the Long Bar Timer (LBT) to expire to scan for LTE systems (i.e. LTE networks/cells), the UE (through the BSR algorithm, for example) may scan for LTE cells if the device is in a “driving” or non-stationary state for at least a specified time period (e.g. for at least a specified number “x” of seconds). This is possible as the UE has knowledge about the existing LTE coverage based on the 1× availability. Hence, when a UE is operating on a CS network, e.g. in a 1× system, the UE may perform scans for LTE cells (e.g. through a BSR algorithm) when the UE has changed its location, and not perform the scan(s) if the UE remains stationary. The algorithm may also take into consideration a hysteresis timer to avoid any “ping-pong” effect.

The embodiments described above account for cases when an LTE network is barred for longer durations, but doesn't address those cases in which a UE device is in cell selection mode (acquisition mode). It has been demonstrated during lab tests, that during multiple attempts the entire scan process may take more than 35-40 seconds, which may result in CS page misses. The UE may become CS capable while camped (i.e. forced to remain) on LTE (during eCSFB) only if the CS registration has happened while the UE was camped on LTE through an S101/S102 interface. Accordingly, there is an intermediate stage when the UE is incapable of making CS calls or accepting CS pages when the UE is in LTE acquisition state. In this case the CS is being restricted to 1×, and even after camping on LTE, the UE may not register on to 1× until it receives the SIB-8 parameters with the relevant CSFB Information Elements (IEs) configured.

In one set of embodiments, when the UE loses acquisition of an LTE network and it loses its CSFB credentials, the UE may camp on 1× first to perform 1× registration to be able to make/accept CS calls. During this phase, the UE may also remain in Suspend/Resume LTE (SRLTE) mode to attempt to acquire an LTE network/cell. Therefore, when the CSFB capability is not present, the UE may attempt to remain in SRLTE mode in such a way that allows the priority between the radio resources for different 1× and LTE stages to be properly available. Once the UE acquires an LTE network, the UE may receive system information parameters (e.g. SIB-8 parameters). If the SIB-8 parameters have eCSFB related IEs configured, then the UE may attempt to register for 1× via LTE as mentioned above, otherwise the UE may attempt to camp (remain) on both radio access technology (RAT) networks, for example when operating in SRLTE mode.

### Optimized CSFB Based on Movement of the UE Device

As previously mentioned, when a UE device is on a CS network, e.g. a 1X network, the UE may scan for LTE networks to get back to an LTE network (cell) as soon as possible. If, as a result of the scan, the UE finds an LTE system, but the LTE system does not support CSFB, the UE may not expect to receive messages that include parameters usable by the UE to acquire the LTE network, and may therefore not be able to connect to the LTE network. However, instead of barring the LTE system/network outright, the UE may determine, based on the motion status of the UE, whether or not to scan for LTE networks prior to the expiration of a specified time duration, e.g. prior to the expiration of a Long Bar Timer (LBT).

If the UE is stationary, or in a stationary state, the expectation of the LTE cell coverage changing is minimal. However, if the UE is moving, or in a non-stationary state, there is a higher probability of the LTE cell coverage changing. In other words, if the UE is in a designated “driving” or non-stationary state, there is a greater chance of the UE migrating into the coverage area of a different LTE cell, in contrast to the UE remaining in the coverage area of the same LTE cell when the UE is in a designated “stationary” state. Consequently, the CSFB and/or eCSFB parameter values broadcast by the network (e.g. by a managing base station servicing the network) may be different from what those parameter values were at the UE's original location. In such cases, the UE may scan for the LTE system when in a non-stationary state. More specifically, the UE may decide to perform a scan for LTE networks if the UE has been in a “driving” (non-stationary) state for at least a specified time period. That is, instead of the UE waiting for a specified timer (e.g. LBT) to expire to scan for LTE networks after having determined that an identified LTE network does not support CSFB/eCSFB, the UE may (through a BSR algorithm, for example) scan for LTE cells if the UE has remained in a “driving” state for a specified time duration. This may be made possible in part by information acquired by the UE about the existing LTE coverage based on the availability of the CS network, e.g. based on 1× availability. Hence, a wireless communication device (or UE) operating on a CS system, e.g. a 1× system, may perform a BSR prior to expiration of an LTE bar period if the wireless communication device has changed its location, and may not perform a BSR prior to the expiration of that bar period if the wireless communication device has remained stationary. Overall, this may prevent the wireless communication device from being forced to remain on a CS network (e.g. on a 1× network) when the wireless communication device is moving. Movement may be determined based on the wireless communication device's internal motion sensor/processor, or from an input signal received from a cell tower, or various other means. Furthermore, searches for LTE networks may be scaled according to the rate of movement, e.g. driving, walking, cycling, etc.

### Optimized CSFB Based on SRLTE

Some wireless service providers may have inadequate LTE coverage, and may further have roaming agreements with many small wireless service operators that don't support CSFB/eCSFB. Because of the inadequate coverage, the UE may enter the LTE acquisition mode (or acquisition state, i.e. cell selection mode) as a result of losing LTE coverage. When attempting to completely turn off LTE, the overall time to search through all the bands (e.g. 6 or 7 bands together) may be about 35-40 seconds, and may be even higher in some cases. The UE may enter a marginal field of coverage, and in some cases may even be able to decode the Physical Broadcast Channel (PBCH) and declare partial acquisition, only to again lose the coverage, go to different bands, and go through the cycles of the acquisition state. In some cases a time period of 90 seconds might elapse without any coverage, all while the UE is scanning For example, the UE may become CS capable while camped on LTE (during CSFB/eCSFB) only if the CS registration has happened while camping on LTE through S101/S102 interface. This means that there is an intermediate stage when the device is incapable of making CS calls or accepting CS pages when the UE is in LTE acquisition state.

To put it another way, in many instances during periods of (LTE) scanning activity the UE may constantly miss the CS pages (e.g. 1× pages). It is therefore desirable to find the best way to identify what networks (of what RATs) are available. Two main frequencies, LTE frequency and CS (e.g. 1×) frequency may be identified with corresponding wake up cycles. When the UE loses LTE acquisition, it may lose its CSFB credentials and may camp on a CS network first to perform CS registration in order to be able to make/accept CS calls. During this phase, the UE may try to remain in SRLTE mode to try to acquire an LTE network. Thus, when the CSFB capability doesn't exist, then UE may operate in SRLTE mode such that the priority between the radio resources for different CS (e.g. 1×) and LTE stages are properly available. That is, the UE may maintain its state on both frequency bands, i.e. on both LTE and 1× in this case (maintain its state on both different RAT networks). Whenever the UE might get held up in an inadequate LTE coverage area, the UE may be allowed to check messages to see if the UE can decode any status during that time. Unlike for CSFB, in this case checking for overhead messages may be performed over the LTE system. Once LTE is acquired, the UE may receive network system parameters (e.g. SIB-8 parameters), and if the parameters have CSFB/eCSFB related IEs configured, then the UE may attempt to register the CS network via LTE, otherwise the UE may camp on both RATs, as in SRLTE.

Different units, e.g. units referred to as a call manager unit and a call processing unit, respectively, may be operated together to determine if the UE is CSFB registered or not. These units may be used to determine whether the overhead messages of the IEs have been received on the SIB-8 to see if the UE is capable of performing CSFB registration or not. Based on that determination, the UE may keep switching between CSFB and SRLTE mode, to take advantage of the situation when the UE has no chance to lock onto LTE, i.e. the UE has no chance to acquire an LTE network. In SRLTE mode, the LTE may have the lowest priority, and CS services may have the highest priority for RF resources. So whenever the UE goes back and decodes the (above referenced) pages, the CS page may be designated to have the highest priority, so the 1×(CS) system may always wake up on that. In other words, the UE may be operated to wake up on its CS cycle to look for coverage. In this manner the UE may perform a periodic wake up to see if a network is available.

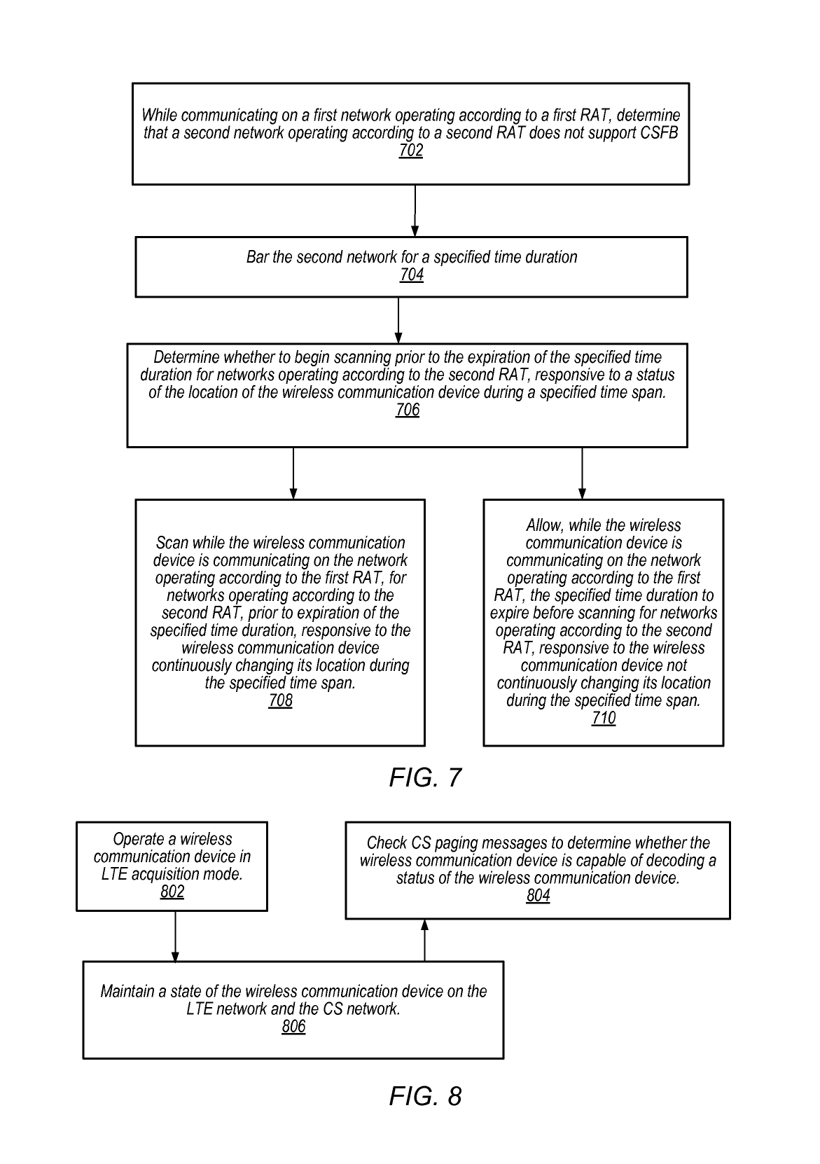

### FIG. 7

FIG. 7 shows a flowchart diagram illustrating an exemplary method for performing optimized circuit switched fallback operation in wireless devices, according to some embodiments. At 702, while communicating on a first network operating according to a first RAT (e.g. a CS network), a wireless communication device may determine that a second network operating according to a second RAT (e.g. an LTE network) does not support CSFB. The wireless communication device may bar the second network for a specified time duration (704). The time duration may correspond to a Long Bar Timer, for example. The wireless communication device may also determine whether to begin scanning prior to the expiration of the specified time duration for networks operating according to the second RAT, responsive to a status of a location of the wireless communication device during a specified time span (706). The specified time span may correspond to a Better System Re-selection (BSR) algorithm used by the wireless communication device to more efficiently manage CSFB operations. Responsive to the wireless communication device continuously changing its location during the specified time span, the wireless communication device may scan—while the wireless communication device is communicating on the network operating according to the first RAT—for networks operating according to the second RAT, prior to expiration of the specified bar duration (708). Responsive to the wireless communication device not continuously changing its location during the specified time span, the wireless communication device—while it is communicating on the network operating according to the first RAT—may allow the specified time duration to expire before scanning for networks that operate according to the second RAT (710).

### FIG. 8

FIG. 8 shows a flowchart diagram illustrating an exemplary method of operating a wireless communication device that can communicate over different radio access technologies, according to some embodiments. At 802, a wireless communication device is in LTE acquisition mode while the wireless communication device is on a CS network. More generally, the wireless communication device is in acquisition mode for a first network operating according to a first RAT, while the wireless communication device is on a second network operating according to a second RAT. At 806, the wireless communication device maintains a state of the wireless communication device on the LTE network (more generally on the first network) and also on the CS network (more generally also on the second network). At 804, the wireless communication device checks CS paging messages to determine whether the wireless communication device is capable of decoding status a status of the wireless communication device at that time.

### Various Embodiments

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A wireless communication device comprising:
an antenna;
radio circuitry coupled to the antenna; and
a processing element coupled to the radio;
wherein the antenna, the radio circuitry and the processing element are configured to interoperate to cause the wireless communication device to:
determine, while communicating on a first network operating according to a first radio access technology (RAT), that a second network operating according to a second RAT does not support circuit switched fallback (CSFB);
bar the second network for a specified time duration responsive to determining that the second network does not support CSFB; and
determine whether to begin scanning prior to an expiration of the specified time duration for other networks operating according to the second RAT, responsive to a status of a location of the wireless communication device during a specified time span.

2. The wireless communication device of claim 1, wherein the antenna, the radio circuitry and the processing element are configured to interoperate to further cause the wireless communication device to:
scan, while communicating on the first network, for the other networks operating according to the second RAT; and
identify a suitable network of the other networks responsive to results of the scan.

3. The wireless communication device of claim 1, wherein the antenna, the radio circuitry and the processing element are configured to interoperate to further cause the wireless communication device to:
scan, while communicating on the first network, for the other networks operating according to the second RAT, prior to expiration of the specified time duration responsive to the wireless communication device changing its location during the specified time span.

4. The wireless communication device of claim 1, wherein the antenna, the radio circuitry and the processing element are configured to interoperate to further cause the wireless communication device to:
allow, while communicating on the first network, the specified time duration to expire before scanning for the other networks operating according to the second RAT, responsive to the wireless communication device not changing its location during the specified time span.

5. The wireless communication device of claim 1, wherein the antenna, the radio circuitry and the processing element are configured to interoperate to further cause the wireless communication device to:
operate in second RAT acquisition mode.

6. The wireless communication device of claim 5, wherein the antenna, the radio circuitry and the processing element are configured to interoperate to further cause the wireless communication device to:
maintain a state of the wireless communication device on the second network, and a third network operating according to the first RAT.

7. The wireless communication device of claim 6, wherein the antenna, the radio circuitry and the processing element are configured to interoperate to further cause the wireless communication device to:
check first RAT paging messages to determine whether the wireless communication device is capable of decoding a status of the wireless communication device.

8. An apparatus comprising:
a processing element configured to:
determine, while a wireless communication device is communicating on a first network operating according to a first radio access technology (RAT), that a second network operating according to a second RAT does not support circuit switched fallback (CSFB);
bar the second network for a specified time duration responsive to determining that the second network does not support CSFB; and
determine whether to begin scanning prior to an expiration of the specified time duration for other networks operating according to the second RAT, responsive to a status of a location of the wireless communication device during a specified time span.

9. The apparatus of claim 8, wherein the processing element is further configured to:
scan, while the wireless communication device is communicating on the first network, for the other networks operating according to the second RAT; and
identify a suitable network of the other networks responsive to results of the scan.

10. The apparatus of claim 8, wherein the processing element is further configured to:
scan, while the wireless communication device is communicating on the first network, for the other networks operating according to the second RAT, prior to expiration of the specified time duration responsive to the wireless communication device changing its location during the specified time span.

11. The apparatus of claim 8, wherein the processing element is further configured to:
allow, while the wireless communication device is communicating on the first network, the specified time duration to expire before scanning for the other networks operating according to the second RAT, responsive to the wireless communication device not changing its location during the specified time span.

12. The apparatus of claim 8, wherein the processing element is further configured to:
operate the wireless communication device in second RAT acquisition mode.

13. The apparatus of claim 12, the processing element is further configured to:
maintain a state of the wireless communication device on the second network, and a third network operating according to the first RAT.

14. The apparatus of claim 13, wherein the processing element is further configured to:
check first RAT paging messages to determine whether the wireless communication device is capable of decoding a status of the wireless communication device.

15. A non-volatile memory device storing programming instructions executable by a processor to cause a wireless communication device to:
determine, while communicating on a first network operating according to a first radio access technology (RAT), that a second network operating according to a second RAT does not support circuit switched fallback (CSFB);
bar the second network for a specified time duration responsive to determining that the second network does not support CSFB; and
determine whether to begin scanning prior to an expiration of the specified time duration for other networks operating according to the second RAT, responsive to a status of a location of the wireless communication device during a specified time span.

16. The non-volatile memory device of claim 15, wherein the programming instructions are executable by the processor to further cause the wireless communication device to:
scan, while communicating on the first network, for the other networks operating according to the second RAT; and
identify a suitable network of the other networks responsive to results of the scan.

17. The non-volatile memory device of claim 15, wherein the programming instructions are executable by the processor to further cause the wireless communication device to:
scan, while communicating on the first network, for the other networks operating according to the second RAT, prior to expiration of the specified time duration responsive to the wireless communication device changing its location during the specified time span.

18. The non-volatile memory device of claim 15, wherein the programming instructions are executable by the processor to further cause the wireless communication device to:
allow, while communicating on the first network, the specified time duration to expire before scanning for the other networks operating according to the second RAT, responsive to the wireless communication device not changing its location during the specified time span.

19. The non-volatile memory device of claim 15, wherein the programming instructions are executable by the processor to further cause the wireless communication device to:
operate in second RAT acquisition mode;
maintain a state of the wireless communication device on the second network, and a third network operating according to the first RAT; and
check first RAT paging messages to determine whether the wireless communication device is capable of decoding a status of the wireless communication device.

20. The non-volatile memory device of claim 15, wherein the first network is a circuit switched network and the second network is a packet switched network.
